(19) United States
(12) Patent Application Publication
(10) Pub. No.: US 2006/0244665 A1
(43) Pub. Date: Nov. 2, 2006

(54) Antenna assembly for use in a portable telecommunication device

(75) Inventor: Hao-Chun Tung, Chin Cheng Chen (TW)

Correspondence Address: LADAS & PARRY, 26 WEST 61ST STREET, NEW YORK, NY, 10023, US

(73) Assignee: BENQ CORPORATION

(21) Appl. No.: 11/414,451

(22) Filed: Apr. 28, 2006

(30) Foreign Application Priority Data
Apr. 29, 2005 (TW) 94114031

(51) Int. Cl. H01Q 1/24

(52) U.S. Cl. 343/702; 343/700 MS

(57) ABSTRACT

An antenna assembly is used in a telecommunication device to transmit and receive wireless signals. The telecommunication device includes a circuit board having a signal-processing circuit for processing the wireless signals. The antenna assembly includes a base member for disposing on an upper surface of the circuit board, a grounding metal layer for disposing on a lower surface of the circuit board, and a bent radiating metal strip fabricated on the base member. The bent radiating metal strip transmits the wireless signals. The antenna assembly further includes a feeding strip extending from the bent radiating metal strip and electrically coupled to a central portion of the circuit board for feeding the wireless signals to the signal-processing circuit.

### FIELD OF THE INVENTION

The present invention relates to an antenna assembly, more particularly to a built-in antenna assembly for use in a mobile phone.

### BACKGROUND OF THE INVENTION

Due to rapid innovation in the telecommunication technology, a mobile phone becomes an important tool for a person to communication with one another. FIG. 1 is a conventional mobile phone 10 of foldable type (generally known as flip phone) to include an externally imposed antenna assembly 11. The antenna assembly 11 generally includes a radiating metal strip of a helix configuration. It is found that when the conventional mobile phone 10 (having such type of antenna assembly 11) is operated under the high-frequency band, some problems arise. The antenna assembly 11 is said to suffer from “Null portion on radiation pattern” phenomena. Referring to FIG. 2, the conventional mobile phone 10 is usually provided with a built-in antenna assembly in order to provide aesthetic appearance thereof. As illustrated, the main body of the conventional mobile phone 10 defines a space 12 at the top portion thereof for receiving the antenna assembly such that when the conventional mobile phone 10 is operated under the high-frequency band (as in Digital Cellular System or Personal Cellular System), there still exists the problem of the “Null portion on radiation pattern” phenomena, thereby rendering the conventional mobile phone 10 to have unstable transmitting and receiving quality. Presence of the “Null portion on radiation pattern” phenomena may lead to a dead space, in which, the signal strength is relatively weak for establishing communication with another mobile phone. Therefore, the problem of aforesaid “Null portion on radiation pattern” phenomena should be taken into serious consideration during the designing of the antenna assembly so as to reduce the affect caused thereby.

FIG. 3 shows a planar view of the conventional mobile phone 10 of FIG. 2 in an unfolded position. As illustrated, the conventional mobile phone 10 includes a lower casing provided with a lower printed circuit board 22, an upper casing provided with an upper printed circuit board 20, and a flexible printed circuit board 18 for establishing an electrical communication between the upper and lower printed circuit boards 20, 22. The radiating metal strip 16 is mounted within the lower casing 22 at the space 12 via a base support 14 generally made from insulated material. The lower printed circuit 22 has a signal-processing circuit (not shown) for processing the wireless signals. The radiating metal strip 16 is used for transmitting and receiving wireless signals under dual bands. Since dimension and the mounting position of the flexible printed circuit board 18 can affect the impedance matching of the antenna assembly, the size and its location of the flexible printed circuit board 18 in the lower casing should be considered seriously during the designing and construction of the antenna assembly.

FIG. 3B is an enlarged view of a portion of the lower casing, wherein the antenna assembly 30 includes the base support 14 and the radiating metal strip 16. The radiating metal strip 16 includes a main strip section fabricated on the base support 14 and a feeding strip 160 having feeding terminal 162 terminating at a left side of the lower circuit board 22 for coupling with the signal-processing circuit. The radiating metal strip 16 has an area of 30×8×12 mm³, and a total length of 115 mm (roughly ⅜ wavelength of the first operating frequency). The left side coupling of the feeding strip 160 to the signal-processing circuit brings some disadvantages. For example, when the conventional mobile phone is operated under the high frequency (the Digital Cellular System ranges from 1710 to 1880 MHz), the antenna assembly is said to suffer from “Null portion on radiation pattern” phenomena, in which, the signal strength is relatively weak for establishing communication with other mobile phones.

FIG. 3C illustrates a diagram of an effective isotropic radiation power measured when the conventional mobile phone of DCS 885 is under operation in the transmit channel, wherein, all the measured values illustrated in FIG. 3B are obtained by normalizing the maximum values measured. When the conventional mobile phone is operated under 1784 MHz, the collapse of radiation-field is advertently aggravated in the −y direction of the X-Y plane. Under this condition, the largest difference of signal strength may tend to 5 dBi. When the conventional mobile phone of DCS 886 is operated under 1879.8 MHz in the receive channel, the antenna assembly has RSSI (receive signal strength index) of roughly −109.6 dB and the average sensitivity of −97.8 dB in the X-Y plane. In other words, the higher the frequency of the antenna assembly, the heavy the Null portion on radiation pattern phenomena becomes. The largest difference of signal strength may tend as far as 11.8 dB.

Moreover, an experiment carried out reveals that when the conventional mobile phone is operated under the PCS bandwidth, the Null portion on radiation pattern phenomena is the worst. Therefore, it is the object of the present invention to provide a new design for the antenna assembly to effectively solving the problem of the Null portion on radiation pattern phenomena that occurs during transmitting and receiving wireless signals under high frequency range, thereby improving the transmitting and receiving ability of the conventional mobile phone.

### SUMMARY OF THE INVENTION

The object of the present invention is to provide a new design of a built-in antenna assembly for use in a telecommunication device, such as a mobile phone.

Another object of the present invention is to provide an antenna assembly including a radiating metal strip having a feeding strip coupled to the central portion of a circuit board for feeding wireless signals to the signal-process circuit so as to possess an omni-directional radiating field during the operation thereof.

In one aspect of the present invention, a built-in antenna assembly is provided for use in a mobile unit to transmit (send or receive) wireless signals, the mobile unit including a circuit board having a signal-processing circuit for processing the wireless signals. The antenna assembly accordingly includes: a base member for disposing on an upper surface of the circuit board; a grounding metal layer for disposing on a lower surface of the circuit board; and a bent radiating metal strip fabricated on the base member, and a feeding strip extending outwardly from the bent radiating metal strip and coupled to a central portion of the circuit board for feeding wireless signals to the signal-processing circuit. When the mobile unit is operated so as to transmit the wireless signals, a uniform current flows throughout an entire external surface of the grounding metal layer by virtue of electromagnetic field caused due to operation of the mobile unit to generate an omni-directional radiating field for the antenna assembly.

In another aspect of the present invention, an antenna assembly is provided for use in a mobile unit to transmit and receive wireless signals, the mobile unit including an upper circuit board and a lower circuit board. The lower circuit board has a signal-processing circuit for processing the wireless signals. The antenna assembly includes: a base member for disposing on an upper surface of the lower circuit board; a first grounding metal layer for disposing on a lower surface of the lower circuit board; a bent radiating metal strip fabricated on the base member; and a feeding strip extending outwardly from the bent radiating metal strip to pass through a central portion of the lower circuit board for coupling and feeding wireless signal to the signal-processing circuit. When the mobile unit is operated so as to transmit the wireless signals, a uniform current flows throughout an entire external surface of the grounding metal layer by virtue of electromagnetic field caused due to operation of the mobile unit to generate an omni-directional radiating field for the antenna assembly.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a conventional mobile phone provided with an externally imposed antenna assembly;

FIG. 2 is a perspective view of another conventional mobile phone provided with a built-in antenna assembly;

FIG. 3A shows a planar view of the conventional mobile phone of FIG. 2;

FIG. 3B shows an exploded and fragmentary view of the conventional mobile phone of FIG. 2, illustrating how the antenna assembly is mounted therein;

FIG. 3C illustrates a radiating field of the antenna assembly of the conventional mobile phone of FIG. 2;

FIG. 4A shows an exploded and fragmentary view, illustrating how the antenna assembly is mounted in the first embodiment of a mobile phone according to the present invention;

FIG. 4B illustrates a radiating field generated when the mobile phone of FIG. 4A is under operation;

FIG. 5A shows an exploded and fragmentary view, illustrating how the antenna assembly is mounted in the second embodiment of a mobile phone according to the present invention; and

FIG. 5B is a spread-out view of the antenna assembly mounted in the second embodiment of the mobile phone according to the present invention.

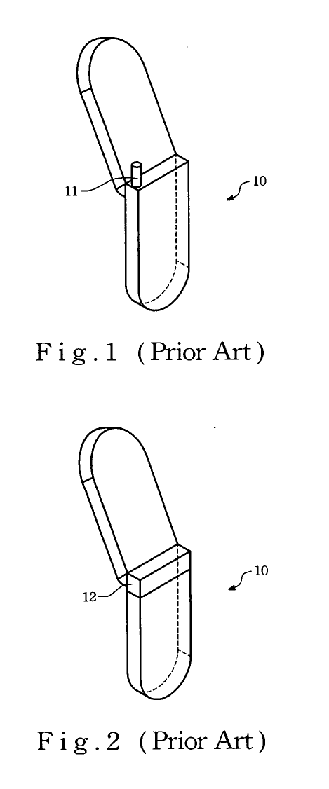

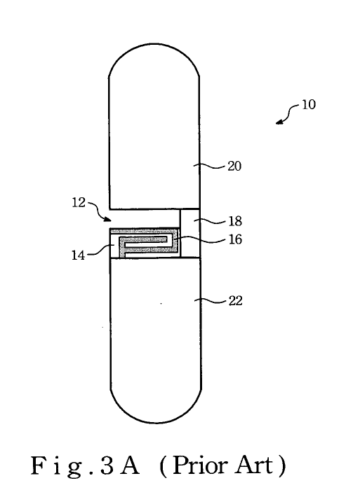

### DETAILED DESCRIPTIONS OF THE PREFERRED EMBODIMENTS

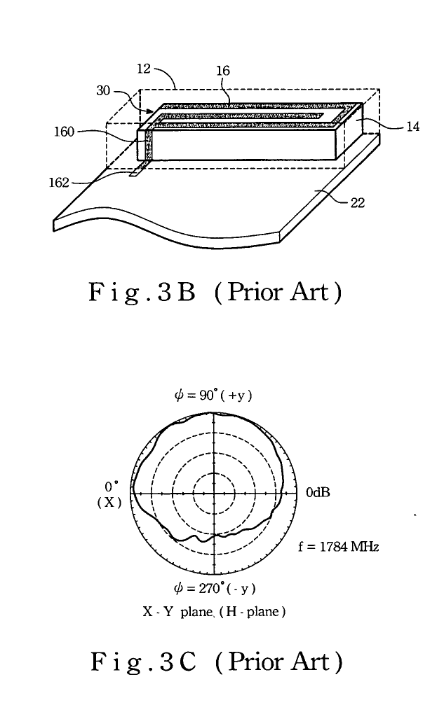

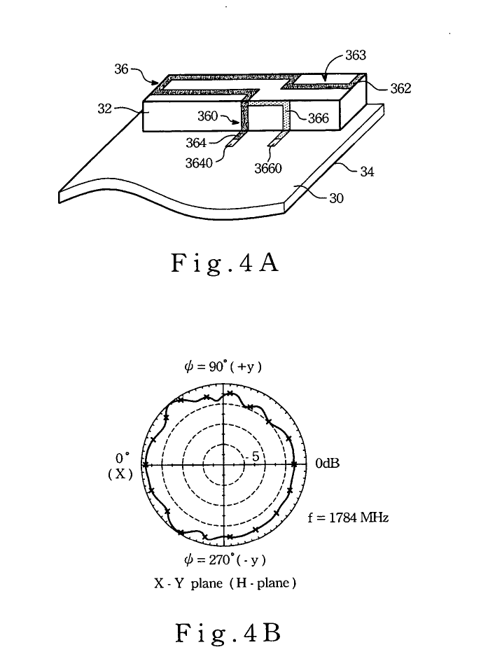

Referring to FIG. 4A, a perspective and exploded view of the first embodiment of a wireless telecommunication device (such as a mobile phone 10 of FIG. 3) according to the present invention is shown to include a casing (not shown) consisting of a lower casing half and an upper casing half which is coupled pivotally to the lower casing half, a circuit board 30 disposed in the lower casing half, a signal-processing circuit (not visible) fabricated on the circuit board 30, and an antenna assembly.

As illustrated, the antenna assembly is mounted within the space 12 (see FIG. 3) of the lower casing half, wherein the upper and lower circuit boards of the lower and upper casing halves are electrically coupled to each other via the flexible printed circuit board 18 as shown in FIG. 3. The antenna assembly of the present invention includes a base member 32, a grounding metal layer 34, a bent radiating metal strip 36, a feeding strip 364, and a ground-connecting strip 366. The base member 32 is disposed on an upper surface of the circuit board 30 adjacent to one end portion thereof so as to provide a better radiating effect once the bent radiating metal strip 36 is mounted thereon.

The grounding metal layer 34 is disposed on a lower surface of the circuit board 30 offset from the base member 32 thereof. The bent radiating metal strip 36 is fabricated on the base member 32. The base member 32 is generally made from a substance having a low dielectric coefficient, such as plastic material and air medium, so that the bent radiating metal strip 36 is protruded into the air. In this embodiment, the bent radiating metal strip 36 further includes two end portions respectively defining a short-circuit strip section 360 and an open-circuit strip section 362. The short-circuit strip section 360 and the open-circuit section 362 of the bent radiating metal strip 36 are constructed to have an effective current path of ⅜ wavelength to conform to the operating frequency of the transmitting and receiving signals. The total length of the bent radiating metal strip 36 is arranged to be compatible with the principle of ⅜ of the wavelength to conform to the operating frequency. However, the total length may differ according to dimension change of the base member 32. Note the region 363 in FIG. 4A is arranged for isolating the bent radiating metal strip 36 with respect to the flexible printed circuit board (not shown), thereby permitting the bent radiating metal strip 36 to avoid the disturbance caused by the flexible printed circuit board.

The feeding strip 364 is connected to the short-circuit strip section 360, and has a feeding terminal 3640 coupled to a central portion of the circuit board 30 for feeding the signal-processing circuit with wireless signals. The grounding-connecting strip 366 has a first end coupling with the short-circuit strip section 360 and a second end extending through the conducting hole 3660 in the circuit board 30 for coupling electrically to the grounding metal layer 34. The grounding-connecting strip 366 is used for adjusting the impedance matching of the antenna assembly. When the mobile phone of the present invention is operated in order to transmit and receive the wireless signals, a uniform current flows throughout the entire external surface of the grounding metal layer 34 by virtue of electromagnetic field caused due to operation of the mobile phone to generate an omni-direction radiating field of the antenna assembly.

FIG. 4B shows the measured diagram, illustrating the effective isotropic radiating power (EIRP) of the DCS 885 mobile phone, wherein all the signal strength are obtained by normalizing the maximum value measured. Under this condition, the mobile phone is operated at 1784 MHz; the antenna assembly has no Null portion on radiation pattern in −y direction of the X-Y plane so that the largest difference of signal strength is 2.5 dBi. In addition, in case the DCS 885 mobile phone is operated in 1879.8 MHz, the same has the effective isotropic radiating power is −108.2 dB while the average sensitivity is −104.3 dB along the X-Y plane. In other words, the higher in the operating frequency, the heavy the Null portion on radiation pattern phenomena there is, but there is only a signal-strength difference of 3.8 dB. Thus when the antenna assembly of the present invention is compared to the conventional ones shown in FIG. 3A, the present antenna assembly has lesser RSSI of 1.4 dBi, but the better sensitivity of 6.5 dBi along the X-Y plane.

Note that the antenna assembly of the present invention can be installed within the space 12 of the foldable mobile phone shown in FIG. 3. Alternately, the same can be installed in the mobile phone of a single-piece type (i.e. there is no upper circuit board). The scope of the present invention should not be limited to the aforesaid embodiment. Several modifications can be designed without departing the scope and limits of the present invention.

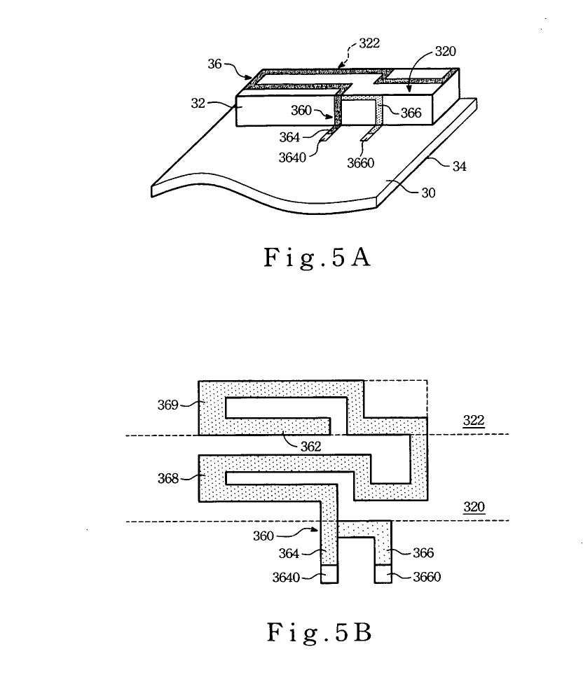

FIG. 5A shows the second embodiment of the mobile phone of the present invention. The only difference resides in that the base member 32 has a first face 320 disposed at an elevation above the upper surface of the circuit board 30, a second face 322 extending perpendicularly from the first face 320. The bent radiating metal strip 36 includes a first section 368 that is mounted on the first face 320 and that is integrally formed with the open-circuit strip section 360, and a second section 369 that is mounted on the second face 322, that extends integrally from the first section 369 and that is integrally formed with the short-circuit strip section 362.

In summary, the antenna assembly employed in the mobile phone of the present invention provides the following advantages over the conventional techniques:

(1) By changing the position of the feeding strip on the circuit board for coupling with the signal-processing circuit, the problem of Null portion on radiation pattern phenomena caused when the mobile phone under high frequency band is improved; and

(2) The antenna assembly provides the omni-direction radiating field throughout the entire surface of the grounding metal layer, thereby lowering the burden caused on the circuit board, which, in turn, enhance the transmitting and receiving ability of the mobile phone of the present invention.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. An antenna assembly for a mobile unit to transmit wireless signals, the mobile unit including a circuit board having a signal-processing circuit for processing the wireless signals, the antenna assembly comprising:
a base member for disposing on an upper surface of the circuit board;
a grounding metal layer for disposing on a lower surface of the circuit board; and
a bent radiating metal strip fabricated on the base member, the bent radiating metal strip for transmitting the wireless signals;
a feeding strip extending from the bent radiating metal strip and electrically coupled to a central portion of the circuit board for feeding the wireless signals to the signal-processing circuit;
whereby, when the mobile unit transmits the wireless signals, a uniform current flows throughout the grounding metal layer to generate an omni-directional radiating field for the antenna assembly.

2. The antenna assembly according to claim 1, wherein the bent radiating metal strip has two end portions respectively defining a short-circuit strip section and an open-circuit strip section, the antenna assembly further comprising:
a ground-connecting strip coupled with the short-circuit strip and the grounding metal layer through a conductive hole of the circuit board, the ground-connecting strip being used for adjusting impedance matching of the antenna assembly.

3. The antenna assembly according to claim 2, wherein the short-circuit strip and the open-circuit strip have an effective current path of ⅜ wavelength conforming to an operating frequency of the wireless signals.

4. The antenna assembly according claim 1, wherein the base member has a first face and a second face, the bent radiating metal strip further including:
a first metal strip fabricated on the first face; and
a second metal strip fabricated on the second face.

5. The antenna assembly according to claim 1, wherein the mobile unit is a mobile phone.

6. An antenna assembly for a mobile unit to transmit wireless signals, the mobile unit including an upper circuit board and a lower circuit board, the lower circuit board having a signal-processing circuit for processing the wireless signals, the antenna assembly comprising:
a base member for disposing on an upper surface of the lower circuit board;
a first grounding metal layer for disposing on a lower surface of the lower circuit board;
a bent radiating metal strip fabricated on the base member; and
a feeding strip extending from the bent radiating metal strip and electrically coupled to a central portion of the lower circuit board for feeding the wireless signals to the signal-processing circuit;
whereby, when the mobile unit transmits the wireless signals, a uniform current flows throughout the first grounding metal layer to generate an omni-directional radiating field for the antenna assembly.

7. The antenna assembly according to claim 7, wherein the bent radiating metal strip has two end portions respectively defining a short-circuit strip section and an open-circuit strip section, the antenna assembly further comprising:
a ground connecting strip coupled with the short-circuit strip section and the first grounding metal layer through a conductive hole of the lower circuit board, the ground connecting strip being used for adjusting impedance matching of the antenna assembly.

8. The antenna assembly according to claim 8, wherein the short-circuit strip section and the open-circuit strip section have an effective current path of ⅜ wavelength conforming to an operating frequency.

9. The antenna assembly according claim 7, wherein the base member has a first face and a second face, the bent radiating metal strip further including:
a first metal strip fabricated on the first face; and
a second metal strip fabricated on the second face.

10. The antenna assembly according to claim 7, further comprising a second grounding metal layer mounted on the upper circuit board.

11. The antenna assembly according to claim 11, further comprising a flexible printed circuit board for electrically interconnecting the first and second grounding metal layers of the upper and lower circuit boards.

12. The antenna assembly according to claim 7, wherein the mobile unit is a mobile phone.
